(19) United States
(12) Patent Application Publication
(10) Pub. No.: US 2007/0135573 A1
(43) Pub. Date: Jun. 14, 2007

(54) Microgel-containing thermosetting plastics composition

(76) Inventors: Torsten Ziser, Birkenau (DE); Thomas Fruh, Limburgerhof (DE); Ludger Heiliger, Neustadt (DE); Werner Obrecht, Moers (DE)

Correspondence Address: LANXESS CORPORATION, 111 RIDC PARK WEST DRIVE, PITTSBURGH, PA, 15275-1112, US

(21) Appl. No.: 11/301,704

(22) Filed: Dec. 12, 2005

(30) Foreign Application Priority Data
Dec. 12, 2005 (DE) 10 2004 062 551.4

(51) Int. Cl. C08L 63/00

(52) U.S. Cl. 525/119; 524/1; 977/773

(57) ABSTRACT

The present invention relates to thermosetting plastics compositions containing crosslinked microgels, to processes for the production thereof and to the use thereof for the production of moulded articles or coatings.

### INTRODUCTION

The present invention relates to thermosetting plastics compositions containing crosslinked microgels, to processes for the production thereof and to the use thereof for the production of moulded articles or coatings.

### PRIOR ART

The use of microgels for controlling the properties of elastomers is known (for example, EP-A-405216, DE-A 4220563, GB-PS 1078400, DE 19701487, DE 19701489, DE 19701488, DE 19834804, DE 19834803, DE 19834802, DE 19929347, DE 19939865, DE 19942620, DE 19942614, DE 10021070, DE 10038488, DE 10039749, DE 10052287, DE 10056311 and DE 10061174). Documents EP-A-405216, DE-A-4220563 and GB-PS-1078400 claim the use of CR, BR and NBR microgels in mixtures with double-bond containing rubbers. DE 19701489 discloses the use of subsequently modified microgels in mixtures with double-bond containing rubbers such as NR, SBR and BR.

The use of microgels for the production of thermosetting plastics compositions is not taught in any of these documents. Thermosetting plastics are closely crosslinked polymers having a three-dimensional structure that are insoluble and infusible. Known examples of thermosetting plastics include phenol-formaldehyde resins, melamine-formaldehyde resins, unsaturated polyester resins, epoxide resins, unsaturated polyester resins, RIM polyurethane systems, etc. Thermosetting plastics are conventionally produced by mixing at least two reactive and relatively highly functional components; the functionality of the reactants is typically ≧3. Once the components have been thoroughly mixed, the mixture of the thermoset components is placed into a mould and the mixture left to cure.

However, these resin systems are in many cases brittle and therefore prone to impact damage. Many methods for increasing the impact strength of resin systems of this type have been investigated. As a result of such investigations, numerous new epoxide resin monomers have been introduced on the market. Other attempts to improve resin strength have consisted in incorporating soluble thermoplastics or elastomers in the resin system.

U.S. Pat. No. 4,656,208 discloses a multiphase system in which a reactive polyether sulphone oligomer and an aromatic diamine curing agent react to form the complex multiphase domains.

DE 3782589 T2 (EP 0259100 B1) discloses a thermosetting plastic that has a vitreous discontinuous phase including a rubber phase. During production of the thermosetting plastics composition, the rubber phase is formed in situ using a liquid rubber during the formation of the thermosetting plastics composition.

U.S. Pat. No. 5,089,560 discloses a curable matrix resin formulation to which 1 to 25% by weight of crosslinked carboxylated rubber particles are added. The smallest particle size of the rubber particles is in the range from 1 to 75 μm, corresponding to 1,000 to 75,000 nm. The use of smaller rubber particles is not taught.

Similarly, U.S. Pat. No. 5,532,296 (corresponding to DE 69232851 T2) discloses an impact-resistant, heat-curable resin system containing from approximately 1 to approximately 10% by weight relative to the total system weight of a functionalised, lightly crosslinked elastomer in the form of preformed particles. The size of the particles is between 2 and 75 μm, corresponding to 2,000 to 7,5000 nm. The use of smaller rubber particles is not taught.

An object of the present invention was, inter alia, to improve the mechanical characteristics of thermosetting plastics compositions, such as the impact strength and elongation at break, while at the same time maintaining the Shore hardness. A further object of the present invention was reproducibly to provide thermosetting plastics compositions having a particularly homogeneous distribution of the dispersed elastomer phase. The inventors found that the use of particularly finely divided microgels prevents macroscopic inhomogeneities, which can produce cracks under mechanical stress, in the thermoset matrix and leads to the formation of particularly homogeneous components with reduced waste.

Moreover, a process for the production of microgel-containing thermosetting plastics compositions was also to be provided that to a certain extent allows an elastomer phase for a given thermosetting plastic to be prepared in advance, in order to avoid the problems associated with the in situ formation of the elastomer phase, such as poor reproducibility.

The present inventors were able to demonstrate that it is possible to achieve the above-described objects, in particular by a particular dispersion of separately produced, particularly finely divided rubber microgels in the precursors to thermosetting plastics production. The use of rubber-like microgels that are provided with specific functional groups at the surface is particularly advantageous.

### DETAILED DESCRIPTION OF THE INVENTION

The present invention thus provides a thermosetting plastics composition containing at least one thermosetting plastics material (A) and at least one crosslinked microgel (B), of which the average primary particle diameter is from 5 to 500 nm.

Microgel or Microgel Phase (B)

The microgel (B) used in the composition according to the invention is preferably a crosslinked, homopolymer- or random copolymer-based microgel. The microgels used according to the invention are therefore preferably crosslinked homopolymers or crosslinked random copolymers. The terms ‘homopolymers’ and ‘random copolymers’ are known to a person skilled in the art and described, for example, in Vollmert, Polymer Chemistry, Springer 1973.

The crosslinked microgel (B) used in the composition according to the invention is preferably a microgel that is not crosslinked by high-energy radiation. The term ‘high-energy radiation’ expediently refers in this case to electromagnetic radiation having a wavelength of less than 0.1 μm.

The use of microgels that are crosslinked completely homogeneously by high-energy radiation is disadvantageous because, on an industrial scale, it throws up industrial safety problems. Moreover, in the event of abrupt stress, tearing effects between the matrix and dispersed phase occur in compositions which have been produced using microgels that are crosslinked completely homogeneously by high-energy radiation, as a result of which the mechanical characteristics, the swelling behaviour and the stress corrosion cracking, etc. are impaired.

The primary particles of the microgel (B) contained in the composition according to the invention preferably have approximately spherical geometry. Microgel particles that may be individually detected by suitable physical methods (electron microscope) and are dispersed in the coherent phase are designated as primary particles to DIN 53206:1992-08 (cf., for example, Römpp Lexikon, Lacke und Druckfarben, Georg Thieme Verlag, 1998). “Approximately spherical” geometry means that, in a thin section view using an electron microscope, the dispersed primary particles of the microgels may be seen to form a substantially circular area. The compositions according to the invention thus differ substantially from dispersed rubber phases produced by the in situ methods, which generally have an irregular shape. The dispersed microgel particles according to the invention maintain their substantially uniform spherical shape, which results from the separate process for preparing the microgel rubber phase, during dispersion in the starting materials for thermoset production virtually without change. The dispersion processes described below allow the fine particle size distribution of the microgels in the microgel latex to be approximately transferred to the thermosetting plastics composition, as virtually no change in the microgels and the particle size distribution thereof occurs during the formation of the thermosetting plastics composition.

In the primary particles of the microgel (B) that are contained in the composition according to the invention, the deviation in the diameter of an individual primary particle, defined as
[(d1−d2)/d2]×100,
wherein d1 and d2 are two arbitrary diameters of an arbitrary section of the primary particle and d1>d2, is preferably less than 250%, more preferably less than 200%, even more preferably less than 100%, even more preferably less than 80% and even more preferably less than 50%.

Preferably at least 80%, more preferably at least 90%, even more preferably at least 95% of the primary particles of the microgel exhibit a diameter deviation, defined as
[(d1−d2)/d2]×100,
wherein d1 and d2 are two arbitrary diameters of an arbitrary section of the primary particle and d1>d2, is preferably less than 250%, more preferably less than 200%, even more preferably less than 100%, even more preferably less than 80% and even more preferably less than 50%.

The above-mentioned deviation in the diameters of the individual particles is determined by the following method. First of all, as described in the examples, a transmission electron micrograph of a thin section of the composition according to the invention is produced. A transmission electron micrograph enlarged by a factor of 1,000 to 2,000 is then produced. In an area of 833.7×828.8 nm, the largest and the smallest diameter of 10 microgel primary particles are manually determined as d1 and d2. If the deviation of all 10 microgel primary particles is in each case less than 250%, more preferably less than 200%, even more preferably less than 100%, even more preferably less than 80% and even more preferably less than 50%, the microgel primary particles exhibit the above-defined feature of deviation.

If the concentration of the microgels in the composition is sufficiently high that the visible microgel primary particles are markedly superimposed, evaluation may be facilitated by suitable prior dilution of the test sample.

In the composition according to the invention, the primary particles of the microgel (B) preferably exhibit an average particle diameter from 5 to 500 nm, more preferably from 20 to 400 nm, even more preferably from 20 to 300 nm, even more preferably from 20 to 250 nm, even more preferably from 20 to 99 nm, even more preferably from 40 to 80 nm.

As the average primary particle diameter of the microgels basically does not change during production of the thermosetting plastics composition of the invention, the average primary particle diameter of the microgels in the thermosetting plastics composition virtually corresponds to the average primary particle size in the dispersion of the microgels in the starting product of the thermosetting plastics material (A) or a solution thereof. Said particle diameter may be determined on such dispersions to DIN 53206 by ultracentrifugation. In order to ensure that the average primary particle diameter is in the claimed range in the crosslinked thermosetting plastics composition according to the invention, a dispersion of the microgels in the starting compounds in which the average particle diameter determined by ultracentrifugation, is in the claimed range is, in particular, to be used. Electron micrographs of the compositions according to the invention obtained in this way demonstrate that the primary particle diameters and also substantially any agglomerates thereof are almost all in the above-defined ranges.

Moreover, the process according to the invention for dispersion of the dried microgels in the starting products of the thermosetting plastics generally allows deagglomeration of the particles with the exception of the primary particle stage. On the one hand, this means that in the thermosetting plastics compositions according to the invention, the average primary particle size preferably substantially corresponds to the average particle size (size=diameter in the context of the present invention) of all of the particles, including the agglomerates. According to the invention, the average diameter of all of the particles in the thermosetting plastics compositions according to the invention is preferably also in the range from 5 to 500 nm, more preferably from 20 to 400 nm, even more preferably from 20 to 300 nm, even more preferably from 20 to 250 nm, even more preferably from 20 to 99 nm, even more preferably from 40 to 80 nm.

On the other hand, the average particle diameter of all of the particles in the thermosetting plastics compositions according to the invention substantially also corresponds to the average diameter of all of the particles in the microgel production latex, which also contains substantially no agglomerates. Since the average diameter of all of the particles in the thermosetting plastics compositions according to the invention remains virtually unchanged as a result of curing or crosslinking during production of the thermosetting plastic, it may also be measured by conventional methods, in particular by ultracentrifugation of the dispersion of the microgels in the starting materials of the thermosetting plastics materials (A), as mentioned below, or else, assuming adequate redispersion during production of the thermosetting plastic, be measured on the microgel production latex and approximately equated with said thermosetting plastics materials (A).

In the composition according to the invention, the microgels (B) that are used expediently comprise fractions which are insoluble in toluene at 23° C. (gel content) of at least approximately 70% by weight, more preferably at least approximately 80% by weight, even more preferably at least approximately 90% by weight. The fraction that is insoluble in toluene is determined in toluene at 23° C. 250 mg of the microgel are steeped in 25 ml toluene for 24 hours at 23° C. while shaking. After centrifugation at 20,000 rpm, the insoluble fraction is separated and dried. The gel content is determined from the quotient of the dried residue and the weighed portion and is given as a percentage.

In the composition according to the invention, the microgels used expediently exhibit a swelling index of less than 80, more preferably less than 60, even more preferably less than 40 in toluene at 23° C. The swelling indices of the microgels (Qi) may thus particularly preferably be between 1-15 and 1-10. The swelling index is calculated from the weight of the solvent-containing microgel steeped in toluene for 24 hours at 23° C. (after centrifugation at 20,000 rpm) and the weight of the dry microgel:
Qi=Wet weight of the microgel/dry weight of the microgel.

In order to determine the swell index, 250 mg, more precisely, of the microgel is steeped in 25 ml toluene for 24 hours while shaking. The gel is centrifuged off, weighed when moist and then dried at 70° C. until a constant weight is reached and weighed again.

In the composition according to the invention, the microgels (B) that are used expediently exhibit glass transition temperatures Tg from −100° C. to +120° C., more preferably from −100° C. to +50° C., even more preferably from −80° C. to +20° C.

In the composition according to the invention, the microgels (B) used expediently exhibit a glass transition temperature range greater than 5° C., preferably greater than 10° C., more preferably greater than 20° C. Microgels that exhibit such a glass transition temperature range are generally, in contrast to completely homogeneously radiation-crosslinked microgels, not completely homogeneously crosslinked. As a result, the change in modulus from the matrix phase to the dispersed phase is not direct. Accordingly, in the event of abrupt stress, there are no tearing effects between the matrix and dispersed phase, so the mechanical characteristics, the swelling behaviour and the stress corrosion cracking, etc. are advantageously influenced.

The glass transition temperature (Tg) and the glass transition temperature range (ΔTg) of the microgels are determined by differential scanning calorimetry (DSC). Two cooling/heating cycles are carried out for determining Tg and ΔTg. Tg and ΔTg are determined in the second heating cycle. In order to determine these elements, 10-12 mg of the selected microgel are placed in a Perkin-Elmer DSC sample container (standard aluminium pan). The first DSC cycle is carried out by first cooling the sample with liquid nitrogen to −100° C. and then heating it at a rate of 20 K/min to +150° C. The second DSC cycle is started by immediate cooling of the sample as soon as a sample temperature of +150° C. has been reached. The cooling takes place at a rate of approximately 320 K/min. In the second heating cycle, as in the first cycle, the sample is heated once again to +150° C. The heating rate in the second cycle is again 20 K/min. Tg and ΔTg are determined graphically on the DSC curve of the second heating process. For this purpose, three straight lines are plotted on the DSC curve. The first straight line is plotted on the curved portion of the DSC curve below Tg, the second straight line on the branch of the curve extending through Tg with a reversal point and the third straight line on the branch of the DSC curve above Tg. Three straight lines with two points of intersection are thus obtained. Each point of intersection is characterised by a characteristic temperature. The glass transition temperature Tg is obtained as an average value of these two temperatures and the glass transition temperature range ΔTg is obtained from the difference between the two temperatures.

The homopolymer- or random copolymer-based microgels (B) that are contained in the composition according to the invention and are not crosslinked by high-energy radiation may be produced in a manner known per se (see, for example, EP-A-405 216, EP-A-854171, DE-A 4220563, GB-PS 1078400, DE 197 01 489.5, DE 197 01 488.7, DE 198 34 804.5, DE 198 34 803.7, DE 198 34 802.9, DE 199 29 347.3, DE 199 39 865.8, DE 199 42 620.1, DE 199 42 614.7, DE 100 21 070.8, DE 100 38 488.9, DE 100 39 749,2, DE 100 52 287.4, DE 100 56 311.2 and DE 100 61 174.5). Patent (applications) EP-A 405 216, DE-A 4220563 and GB-PS 1078400 claim the use of CR, BR and NBR microgels in mixtures with double-bond containing rubbers. DE 197 01 489.5 discloses the use of subsequently modified microgels in mixtures comprising rubbers containing double bonds such as NR, SBR and BR.

The production and the characterisation of crosslinked rubber microgels are also disclosed in U.S. Pat. No. 5,395,891 (BR microgels), U.S. Pat. No. 6,127,488 (SBR microgels) and DE 19701487 (NBR microgels). The microgels disclosed in these documents are not modified with specific functional groups. Rubber microgels containing specific functional groups are disclosed, in particular, in U.S. Pat. No. 6,184,296, 19919459 and in DE 10038488. In these publications, the functionalised microgels are produced in a plurality of process steps. In the first step, the basic rubber latex is produced by emulsion polymerisation. Alternatively, commercially available rubber latices may also be taken as a starting point. The desired degree of crosslinking (characterised by the gel content and swelling index) is adjusted in a subsequent process step, preferably by crosslinking the rubber latex with an organic peroxide. The performance of the crosslinking reaction with dicumyl peroxide is disclosed in DE 10035493. Functionalisation is carried out after the crosslinking reaction. In U.S. Pat. No. 6,184,296 the crosslinked rubber particles are modified by sulphur or sulphur-containing compounds and in DE 1 991 9459 and in DE 10038488 the crosslinked rubber latices are grafted with functional monomers such as hydroxyethyl methacrylate und hydroxybutyl acrylate.

In contrast to the multistage synthesis of the functionalised microgels disclosed in the above-mentioned patents (applications), the microgels used according to the invention are preferably produced in a one-stage process in which crosslinking and functionalisation take place during emulsion polymerisation (directly crosslinked microgel).

According to the invention, the term “microgels” expediently refers to rubber particles that are obtained, in particular, by crosslinking the following rubbers:
BR: polybutadiene,
ABR: butadiene/acrylic acid/C1-4 alkylester copolymers,
IR: polyisoprene,
SBR: random styrene/butadiene copolymers having styrene contents from 1-90, preferably 5-50 percent by weight,
X-SBR: carboxylated styrene/butadiene copolymers
FKM: fluorine rubber,
ACM: acrylate rubber,
NBR: polybutadiene/acrylonitrile copolymers having acrylonitrile contents from 5-100, preferably 10-50 percent by weight,
X-NBR: carboxylated nitrile rubbers
CR: polychloroprene
IIR: isobutylene/isoprene copolymers having isoprene contents from 0.5-10 percent by weight,
BIIR: brominated isobutylene/isoprene copolymers having bromine contents from 0.1-10 percent by weight,
CIIR: chlorinated isobutylene/isoprene copolymers having bromine contents from 0.1-10 percent by weight,
HNBR: partially and completely hydrogenated nitrile rubbers
EPDM: ethylene/propylene/diene copolymers,
EAM: ethylene/acrylate copolymers,
EVM: ethylene/vinyl acetate copolymers
CO and
ECO: epichlorohydrin rubbers,
Q: silicone rubbers,
AU: polyester urethane polymers,
EU: polyether urethane polymers
ENR: epoxidised natural rubber or mixtures thereof.

The uncrosslinked microgel starting products are expediently produced by the following methods:

1. Emulsion polymerisation

2. Naturally occurring latices such as natural rubber latex may of course also be used.

In the thermosetting plastics composition according to the invention, the microgels (B) used are preferably ones that may be obtained by emulsion polymerisation and crosslinking.

In the production of the microgels used according to the invention by emulsion polymerisation, the following radically polymerisable monomers are, for example, used: butadiene, styrene, acrylonitrile, isoprene, acrylic and methacrylic acid esters. Tetrafluoroethylene, vinylidene fluoride, hexafluoropropene, 2-chlorobutadiene, 2,3-dichlorobutadiene and double bond-containing carboxylic acids such as, for example, acrylic acid, methacrylic acid, maleic acid, itaconic acid, etc., double-bond containing hydroxy compounds such as hydroxyethyl methacrylate, hydroxyethyl acrylate, hydroxybutyl methacrylate, hydroxypolyethylene glycol methacrylate, methoxypolyethylene glycol methacrylate, stearyl methacrylate, amine-functionalised (meth)acrylate, acrolein, N-vinyl-2-pyrrolidone, N-allyl-urea und N-allyl-thiourea, secondary amino-(meth)-acrylic ester and 2-tert-butylaminoethyl methacrylate und 2-tert-butylaminoethyl methacrylamide, etc. The rubber gel may be crosslinked directly during emulsion polymerisation, for example by copolymerisation with crosslinking multifunctional compounds, or by subsequent crosslinking as described below. Direct crosslinking during emulsion polymerisation is preferred. Preferred multifunctional comonomers are compounds comprising at least two, preferably two to four copolymerisable C═C double bonds, such as diisopropenylbenzene, divinylbenzene, divinylether, divinylsulphone, diallyl phthalate, triallyl cyanurate, triallyl isocyanurate, 1,2-polybutadiene, N,N′-m-phenylene maleimide, 2,4-toluylenebis(maleimide) and/or triallyl trimellitate. Also considered are the acrylates and methacrylates of polyhydric, preferably dihydric to tetrahydric C2 to C10 alcohols such as ethylene glycol, propanediol-1,2, butanediol, hexanediol, polyethylene glycol comprising 2 to 20, preferably 2 to 8 oxyethylene units, neopentyl glycol, bisphenol-A, glycerol, trimethylolpropane, pentaerythritol, sorbitol comprising unsaturated polyesters of aliphatic diols and polyols, and also maleic acid, fumaric acid and/or itaconic acid.

The crosslinking to rubber microgels during emulsion polymerisation may also take place by continuing polymerisation until high conversions are achieved or, in the monomer feed process, by polymerisation with high internal conversions. It is also possible to carry out emulsion polymerisation in the absence of regulators.

For crosslinking the uncrosslinked or lightly crosslinked microgel starting products after emulsion polymerisation, it is best to use the latices that are obtained during emulsion polymerisation. Natural rubber latices may also be crosslinked in this way.

Examples of suitable crosslinking chemicals include organic peroxides such as dicumyl peroxide, t-butylcumyl peroxide, bis-(t-butyl-peroxy-isopropyl)benzene, di-t-butyl peroxide, 2,5-dimethylhexane-2,5-dihydroperoxide, 2,5-dimethylhexin-3,2,5-dihydroperoxide, dibenzoyl peroxide, bis-(2,4-dichlorobenzoyl)peroxide, t-butyl perbenzoate and also organic azo compounds such as azo-bis-isobutyronitrile und azo-bis-cyclohexanenitrile and dimercapto und polymercapto compounds such as dimercaptoethane, 1,6-dimercaptohexane, 1,3,5-trimercaptotriazine und mercapto-terminated polysulphide rubbers such as mercapto-terminated reaction products of bis-chloroethyl formal with sodium polysulphide.

The optimum temperature for carrying out the post-curing is of course dependent on the reactivity of the crosslinking agent. It may be carried out at temperatures from ambient temperature to approximately 180° C., optionally under elevated pressure (cf. Houben-Weyl, Methoden der organischen Chemie, fourth edition, vol. 14/2, page 848). Peroxides are particularly preferred crosslinking agents.

C═C double bond-containing rubbers may also be crosslinked to microgels in dispersion or emulsion with simultaneous partial or optionally complete hydrogenation of the C═C double bond by hydrazine, as disclosed in U.S. Pat. No. 5,302,696 or U.S. Pat. No. 5,442,009 or optionally other hydrogenation agents, for example organometallic hydride complexes.

Before, during or after the post-curing, the particles may optionally be enlarged by agglomeration.

In the production process used according to the invention, microgels that are incompletely homogeneously crosslinked and may exhibit the above-described advantages are always obtained.

Both non-modified microgels comprising substantially no reactive groups, in particular at the surface, and modified microgels comprising functional groups, in particular at the surface, may be used as microgels for preparing the composition according to the invention. Said modified microgels may be produced by chemical reaction of the microgels that have already been crosslinked with chemicals that are reactive toward C═C double bonds. These reactive chemicals are, in particular, compounds by means of which polar groups such as aldehyde, hydroxyl, carboxyl, nitrile, etc., groups and sulphur-containing groups such as mercapto, dithiocarbamate, polysulphide, xanthogenate, thiobenzothiazole and/or dithiophosphoric acid groups and/or unsaturated dicarboxylic acid groups may be chemically bound to the microgels. This also applies to N,N′-m-phenylenediamine The aim of the microgel modification is to improve the microgel compatibility with the matrix in order to achieve good dispersibility during production and also good linking.

Particularly preferred modification methods include the grafting of the microgels with functional monomers and the reaction with low-molecular agents.

The starting materials for the grafting of the microgels with functional monomers is expediently the aqueous microgel dispersion, which is reacted under the conditions of radical emulsion polymerisation with polar monomers such as acrylic acid, methacrylic acid, itaconic acid, hydroxyethyl-(meth)-acrylate, hydroxypropyl-(meth)-acrylate, hydroxybutyl-(meth)-acrylate, acrylamide, methacrylamide, acrylonitrile, acrolein, N-vinyl-2-pyrrolidone, N-allyl-urea and N-allyl-thiourea and also secondary amino-(meth)-acrylic esters such as 2-tert-butylaminoethyl methacrylate und 2-tert-butylaminoethyl methacrylamide.

Microgels having a core/shell morphology are thus obtained, wherein the shell is to exhibit a high degree of compatibility with the matrix. It is desirable that the monomer used in the modification step grafts as quantitatively as possible onto the unmodified microgel. Expediently, the functional monomers are added prior to the complete crosslinking of the microgels.

The following reagents in particular are suitable for a surface modification of the microgels with low-molecular agents: elemental sulphur, hydrogen sulphide and/or alkylpolymercaptans such as 1,2-dimercaptoethane or 1,6-dimercaptohexane, and also dialkyl and dialkylaryl dithiocarbamate and the alkali salts of dimethyl dithiocarbamate and/or dibenzyl dithiocarbamate, also alkyl and aryl xanthogenates such as potassium ethyl xanthogenate und sodium isopropyl xanthogenate and the reaction with the alkali or alkaline-earth salts of dibutyldithiophosphoric acid and dioctyldithiophosphoric acid and dodecyldithiophosphoric acid. The aforementioned reactions may also advantageously be carried out in the presence of sulphur, wherein the sulphur is also incorporated, with the formation of polysulphide bonds. For the addition of this compound, radical initiators such as organic or inorganic peroxides and/or azo initiators may be added.

Modification of double bond-containing microgels, for example by ozonolysis and by halogenation with chlorine, bromine and iodine, is also possible. A further reaction of modified microgels, for example the production of hydroxyl group modified microgels from epoxidised microgels, is also understood as a chemical modification of microgels.

In a preferred embodiment, the microgels are modified by hydroxyl groups, an epoxy, amine, acid anhydride, isocyanate or an unsaturated group (for example C═C), in particular at the surface. The hydroxyl group content of the microgels is determined by reaction with acetic anhydride and titration of the acetic acid hereby released with KOH to DIN 53240 as a hydroxyl value having the units mg KOH/g polymer. The hydroxyl value of the microgels is preferably between 0.1 and 100, more preferably between 0.5 and 50 mg KOH/g polymer.

The amount of modification agent used is determined by the efficacy thereof and individual requirements, and is in the range from 0.05 to 30 percent by weight, based on the total amount of rubber microgel used, 0.5 to 10 percent by weight being particularly preferred.

The modification reactions may be carried out at temperatures from 0-180° C., preferably 20-95° C., optionally under a pressure of 1-30 bar. The modifications may be carried out on rubber microgels in substance or in the form of the dispersion thereof, wherein, in the latter case, organic solvents or even water may be used as a reaction medium. Particularly preferably, the modification is carried out in an aqueous dispersion of the crosslinked rubber.

The use of modified, in particular hydroxy, epoxy, amine, acid anhydride, isocyanurate-modified, microgels or microgels modified by an unsaturated group (for example C═C) is preferred.

The average diameter of the produced microgels may be adjusted with high accuracy, for example, to 0.1 micrometres (100 nm)+/−0.01 micrometre (10 nm), so a particle distribution, for example, wherein at least 75% of all of the microgel particles are between 0.095 micrometres and 0.105 micrometres, is achieved. Other average diameters of the microgels, in particular in the range between 5 and 500 nm, may be produced and used with equal accuracy (at least 75% by weight of all of the particles lie in a range of +10% above and below the peak of the integrated particle size distribution curve (determined by ultracentrifugation)).

This allows the morphology of the microgels dispersed in the composition according to the invention to be adjusted with almost “pinpoint” accuracy, and hence the properties of the composition according to the invention and the thermoset materials produced therefrom, for example, to be adjusted.

The microgels produced in this manner may be worked up, for example, by evaporation, coagulation, by co-coagulation with a further latex polymer, by freeze coagulation (cf. U.S. Pat. No. 2,187,146) or by spray-drying. In the case of working up by spray-drying, commercially available flow promotion agents such as CaCO₃ or silicic acid may be added.

Thermosetting Plastics Materials (A)

Thermosetting plastics compositions according to the invention are, in particular, those that exhibit a shear modulus of more than 10 MPa in the service temperature range (approximately −150 to approximately +200° C.). The shear modulus is determined to DIN ISO 6721-1:1996.

In the composition according to the invention, the ratio by weight of thermosetting plastics material (A) to microgel (B) is expediently 0.5:99.5 to 99.5:0.5, preferably 1:99 to 99:1, more preferably 10:90 to 90:10, particularly preferably 20:80 to 80:20.

The thermosetting plastics material (A) in the thermosetting plastics composition of the invention is preferably selected from the group consisting of thermosetting condensation polymers, thermosetting addition polymers and thermosetting polymerisation materials. The thermosetting condensation polymers are preferably selected from the group consisting of phenolic resins, amino resins, furan resins and polyimides, the thermosetting addition polymers are preferably selected from the group consisting of epoxide resins and polyurethanes, and the thermosetting polymerisation materials are preferably selected from allyl compounds, unsaturated polyesters, vinyl or acrylic esters. Preferably, the thermosetting plastics materials (A) are selected from the group consisting of:
diallyl phthalate resins (PDAP),
epoxide resins (EP),
aminoplastics such as urea-formaldehyde resins (UF), melamine-formaldehyde resins (MF), melamine/phenol-formaldehyde resins (MPF),
phenolics such as melamine-phenol-formaldehyde resins (MP), phenol-formaldehyde resins (PF), cresol-formaldehyde resins (CF), resorcinol-formaldehyde resins (RF), xylenol formaldehyde resins (XF),
furfuryl alcohol-formaldehyde resins (FF),
unsaturated polyester resins (UP),
polyurethane resins (PU)
reaction injection-moulded polyurethane resins (RIM-PU)
furan resins
vinyl ester resins (VE, VU),
polyester-melamine resins
mixtures of diallyl phthalate (PDAP) or diallyl isophthalate (PDAIP) resins.

What are known as RIM polyurethanes, aminoplastics and phenolics, epoxy resins and UP resins are particularly preferred.

Thermosetting plastics materials of this type are known per se. With regard to production of said plastics materials, reference may be made, for example, to Saechtling, Kunststoff Taschenbuch, 28th edition, Chapter 4.17; Ullmann's Encyclopedia of Industrial Chemistry, fifth edition, Vol. A26, 665 ff., “Thermosets” (in this case, production processes in particular); Ullmann ibid. Vol. 9, 547, “Epoxy Resins”; Römpp Lexikon Chemie; tenth edition H-L, entry on thermoset materials and the literature cited in said entry; Elias, Makromoleküle, Vol. 2, Technologie, fifth edition, Chapter 15.6 “Duroplaste”; also to the above-mentioned prior art, in particular regarding epoxy resin systems, such as U.S. Pat. No. 5,089,560, U.S. Pat. No. 5,532,296, EP 0259100, EP 0525418, etc.

The thermosetting plastics compositions according to the invention preferably contain one or more plastics material additives, which are preferably selected from the group consisting of: fillers and reinforcing materials, pigments, UV absorbers, flame retardants, defoaming agents, deaerators, wetting and dispersing agents, fibres, fabrics, catalysts, thickening agents, anti-settling agents, anti-shrinking agents, thixotropic agents, release agents, flow control agents, flatting agents, corrosion inhibitors, slip additives and biocides. The plastics material additives are preferably selected from inorganic and/or organic fillers such as sawdust, cellulose, cotton staples, rayon skeins, mineral fibres, mineral powder, mica, short and long fibres, glass mats, carbon fibres, plasticisers, inorganic and/or organic pigments, flame-retardants, pesticides, for example for destroying termites, means providing protection from gnawing rodents, etc., and other conventional plastics material additives. Fibrous fillers are particularly preferred. These may be contained in the compositions according to the invention in a quantity of up to approximately 40% by weight, preferably up to 20% by weight, based on the total amount of composition.

The invention also relates to the use of crosslinked microgels (B) for the production of thermosetting plastics compositions.

The thermosetting plastics compositions according to the invention are produced, in particular, by a method comprising the following steps:
a) dispersion of the microgel (B) in one or more starting products that are capable of forming the thermosetting plastics material (A) or a solution thereof, which starting products optionally contain plastics material additives, which are advantageously added prior to dispersion,
b) optionally addition of further components and
c) curing of the dispersion obtained.

Particularly preferably, step c) takes place with simultaneous shaping.

The above-mentioned starting products that are capable of forming the thermosetting plastics material (A) are preferably selected for this purpose from monomers, oligomers (prepolymers) or crosslinking agents.

Preferred starting products that are capable of forming the thermosetting plastics material (A) are selected from the group consisting of:
polyols and mixtures thereof,
aliphatic polyols and mixtures thereof, aliphatic polyether polyols and mixtures thereof,
aliphatic polyester polyols and mixtures thereof,
aromatic polyester polyols and mixtures thereof,
polyether polyester polyols and mixtures thereof,
unsaturated polyesters and mixtures thereof,
aromatic alcohols or mixtures thereof,
styrene,
polyisocyanates,
isocyanate resins,
epoxide resins,
phenolic resins,
furan resins,
caprolactam,
dicyclopentadiene,
aliphatic polyamines,
polyamidoamines,
aromatic polyamines,
(meth)acrylates,
polyallyl compounds,
vinyl esters,
state A thermosetting condensation polymers and also
derivatives or solutions of the above-mentioned starting products.

Aliphatic polyols and mixtures thereof, aromatic alcohols, styrene and unsaturated polyesters are particularly preferred.

The above-mentioned further components are, in particular, the further (second) components for forming the thermosetting plastics material, especially the curing agent, for example a polyisocyanate, a polyamine, a formaldehyde donor, styrene, etc. They may also be the above-mentioned plastics material additives, including fibrous fillers.

Curing takes place under the conventional conditions for the thermosetting plastics material.

In a particularly preferred embodiment of the process according to the invention, the microgel (B) and the starting product that is capable of forming the thermosetting plastics material, which starting material optionally contains plastics material additives that are advantageously added prior to dispersion, are treated together by a homogeniser, a ball mill, a bead mill, a roll mill, a triple roller, a single- or multi-screw extruder, a kneader and/or a high-speed stirrer.

In a preferred embodiment, the microgel (B) and the starting product that is capable of forming the thermosetting plastics material are dispersed by a homogeniser, a bead mill, a triple roller and/or a high-speed stirrer. The drawbacks of the bead mill are the comparatively limited viscosity range (usually thin compositions), the complexity of cleaning, the expensive product exchange of the compositions that may be used, and also the wear to the balls and grinding equipment.

Particularly preferably, the compositions according to the invention are homogenised by a homogeniser or a triple roller. The drawbacks of the triple roller are the comparatively limited viscosity range (usually very thick compositions), the low throughput and unclosed mode of operation (poor protection during operation).

Very preferably, the starting products (precursors) that are capable of forming the compositions according to the invention are homogenised by a homogeniser. The homogeniser allows low-viscosity and high-viscosity compositions to be processed at a high throughput (high degree of flexibility). Product exchanges are comparatively rapid and simple.

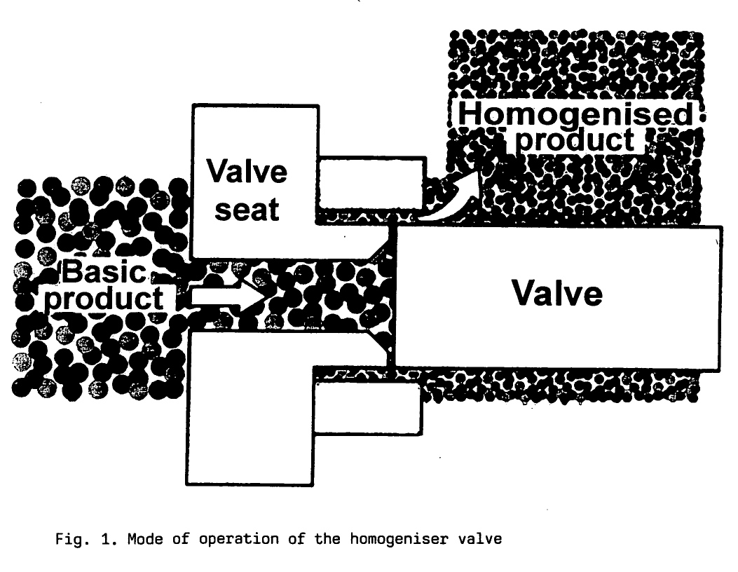

The microgels (B) in the starting product that is capable of forming the thermosetting plastics material are dispersed in the homogenising valve in the homogeniser (see FIG. 1).

In the process used according to the invention, agglomerates are broken down into aggregates and/or primary particles. Agglomerates are physically separable units, during the dispersion of which the primary particle size remains unaltered.

The product to be homogenised enters the homogenising valve at a slow speed and is accelerated to high speeds in the homogenising gap. Dispersion takes place behind the gap principally as a result of turbulence and cavitation (William D. Pandolfe, Peder Baekgaard, Marketing Bulletin of the APV Homogeniser Group—“High-pressure homogenisers: processes, product and applications”).

The temperature of the preliminary-stage microgel dispersion used according to the invention, on entering the homogeniser, is expediently −40-140° C., preferably 20-80° C.

The composition to be homogenised is expediently homogenised in the device at a pressure from 20 to 4000 bar, preferably 100-2000 bar, very preferably 300-1500 bar. The number of cycles is determined by the desired dispersion quality and may vary between 1 and 40, preferably between 1 and 20, more preferably between 1 and 10, even more preferably between 1 and 4.

The thermosetting plastics compositions produced according to the invention accordingly have a particularly fine particle distribution, which is achieved, in particular, as a result of the treatment of the precursors containing the microgel with the homogeniser, which is also extremely advantageous in terms of the flexibility of the process with regard to varying viscosities of the liquid precursors and necessary temperatures, and also in terms of the quality of dispersion. The fine distribution of the microgels (B) in the starting product that is capable of forming the thermosetting plastics material, including the particle distribution of the microgels in the original microgel latex, allows particularly effective distribution of the microgels in the thermosetting plastics material (A), in a way that was not previously possible according to the prior art.

The mechanical characteristics of the thermosetting plastics compositions are thus surprisingly improved.

The resultant microgel pastes of the thermoset material precursors may conveniently be stored until the formation of the thermoset materials as a result of curing, optionally with the addition of curing agents. As a result of their fine distribution, there is no significant settling.

The invention also relates to the thermosetting plastics compositions that may be obtained by the above-described processes.

The invention further relates to the use of the thermosetting plastics compositions according to the invention as a moulded article and as a coating or bonding material. It also includes the production of what are known as microgel-filled prepregs. The invention further relates to the use of the thermosetting plastics compositions according to the invention in electronic components, for example as a housing for electronic devices, and in constructional components, for example as building materials.

The invention further relates to the use of microgels having an average primary particle diameter of preferably 5 to 500 nm as a rheological additive, especially as a thickening agent and/or a thixotropic agent, in one or more starting products that are capable of forming the thermosetting plastics material (A) or a solution thereof, which starting products contain reactants having an average functionality per molecule typically of ≧3, and also compositions containing one or more crosslinked microgels (B), the average primary particle diameter of which is from 5 to 500 nm, and one or more starting products that are capable of forming a thermosetting plastics material (A), wherein at least 20% by weight of the starting products consist of crosslinkable components having an average functionality of ≧3.

The present invention will be described in greater detail by means of the following examples. However, the invention is not limited to the disclosure of the examples.

### EXAMPLES

Examples of Microgel Production and Characterisation

Examples of Microgel Production:

The production of the microgels OBR 980, OBR 1009, OBR 1135, OBR 1155, OBR 1209, OBR 1212, OBR 1225, OBR 1236, OBR 1283, OBR 1320D, Micromorph 4P (OBR 1209), which were used in the further examples, will be described below:

The microgels having the designations OBR 980, OBR 1009 and OBR 1135 were produced according to the teaching of DE 10035493 A1 or WO 02/08328, wherein the amounts of dicumyl peroxide (DCP) given in the following table were used for the crosslinking:

| | DCP |
|---|---|
| Microgel designation | [% by weight] |
| OBR 980 | 2.5 |
| OBR 1009 | 1.0 |
| OBR 1135 | 2.5 |

The microgels OBR 1209, 1212, 1225, 1236, 1283 and OBR 1320 D were produced by emulsion polymerisation, the following monomers being used: butadiene, styrene, trimethylolpropane trimethacrylate (TMPTMA), ethylene glycol dimethacrylate (EGDMA), hydroxyethyl methacrylate (HEMA) and methacrylic acid (MAS). The monomers used for production of the microgels and fundamental formulation components are summarised in the following table:

Table ″Microgel production″

| | | Emulsifiers | | Monomers | | | | | |
|---|---|---|---|---|---|---|---|---|---|
| | | Mersolat | TCD2) | | | TMPTMA | HEMA | | |
| | Water | K30/951) | (20%) | Butadiene | Styrene | (90%) | (96%) | EGDMA | MAS |
| Microgel | [g] | [g] | [g] | [g] | [g] | [g] | [g] | [g] | [g] |
| OBR 1155 | 20,000 | 137 | — | 9500 | — | — | — | 500 | 50.3 |
| | | | | | | | | | (*) |
| OBR 1209 | 20,000 | 137 | 250 | 5070 | 3380 | 1250 | 300 | — | — |
| OBR 1212 | 20,000 | 137 | 250 | 4650 | 3100 | 1250 | 1000 | — | — |
| OBR 1225 | 20,000 | 137 | 250 | 7425 | 825 | 750 | 1000 | — | — |
| OBR 1236 | 20,000 | 137 | — | 7650 | 850 | 500 | 1000 | — | — |
| OBR 1283 | 20,000 | 250 | — | 7830 | 870 | 300 | 1000 | — | — |
| OBR 1320 D | 20,000 | 263 | — | 7830 | 870 | 300 | 1000 | — | — |
| RFL 403 A | 20,000 | 137 | 250 | 4450 | 4650 | 150 | 750 | — | — |

(*) In addition to MAS, 96 g KOH were placed in the reactor
1)Mersolat K 30 ®/95 (Bayer AG) represents the Na salts of long-chain alkyl sulphonic acids (isomer mixture). The active substance content is 95% by weight.
2)Na salt of the reaction product of bis-hydroxyformylated dicyclopentadiene with hexahydrophthalic acid anhydride. An aqueous solution comprising 20% by weight of the active substance was used. (The emulsifier was produced in accordance with U.S. Pat. No. 5,100,945).

For production of the microgels, the amounts of the emulsifiers Mersolat K30/95 and TCD given in the table were dissolved in water and placed in a 40 l autoclave. The autoclave was evacuated three times and nitrogen was introduced. The monomers specified in the table were then added. The monomers were emulsified in the emulsifier solution at 30° C. while stirring. An aqueous solution consisting of 171 g water, 1.71 g ethylene diamine tetraacetic acid (Merck-Schuchardt), 1.37 g iron(II)-sulphate*7H₂O, 3.51 g sodium formaldehyde-sulphoxylate-hydrate (Merck-Schuchardt) and 5.24 g trisodium phosphate*12H₂O was then added.

The reaction was initiated by the addition of 5.8 g 50% p-menthane hydroperoxide (Trigonox NT 50 from Akzo-Degussa), dissolved in 250 g water with 10.53 g Mersolat K30/95 (the amount of water used for this purpose is included in the total amount of water specified in the table).

After a reaction time of 2.5 hours, the reaction temperature was raised to 40° C. After a further reaction time of 1 hour, an identical amount of initiator solution (NT50/water/Mersolat K30/95) was post-activated. The polymerisation temperature, in this case, was raised to 50° C. Once a polymerisation conversion of >95% had been reached, polymerisation was stopped by the addition of an aqueous solution of 23.5 g diethylhydroxylamine dissolved in 500 g water (the amount of water used for this purpose is included in the total amount of water specified in the table).

Unreacted monomers were then removed from the latex by stripping with water vapour.

The latex was filtered and, as in Example 2 of U.S. Pat. No. 6,399,706, stabiliser as added and the mixture coagulated and dried.

The gels were characterised both in the latex state by ultracentrifugation (diameter and specific surface area) and as a solid product with respect to solubility in toluene (OH number and COOH number) and by DSC (glass transition temperature/TG and range of the Tg stage).

The gels were characterised both in the latex state and also partly in the redispersed state in polyol by ultracentrifugation (diameter dz and specific surface area Ospez) and as a solid product with respect to solubility in toluene (gel content, swelling index (QI)), by acidimetric titration (OH number and COOH number) by DSC (glass transition temperature (Tg) and range of the Tg stage).

The analytical data of the microgels used is summarised in the following table.

Table: ″Properties of the microgels used″

| | | | | | Gel | | | | | |
|---|---|---|---|---|---|---|---|---|---|---|
| | Diameter | | | | content | | | Range of | | |
| | d₁₀ | d₅₀ | d₈₀ | Ospez. | [% by | Swelling | Tg | Tg stage | OH number | Acid number |
| Microgel | [nm] | [nm] | [nm] | [m²/g] | weight] | index | [° C.] | [° C.] | [mg_{KOH}/g_{Pol.}] | [mg_{KOH}/g_{Pol.}] |
| OBR 980 | 39 | 48 | 55 | — | 91.7 | 5.6 | — | — | — | — |
| OBR 1009 | 41.9 | 56 | 65.9 | 112 | 95.4 | 6.0 | −13.5 | — | — | — |
| OBR 1135 | 102 | 120 | 131 | 52.2 | 97.8 | 3.7 | −39 | — | 4.2 | 4.6 |
| OBR 1155 | 59.6 | 75.8 | 86.2 | 88.5 | 97.0 | 8.3 | −77 | 10.2 | 1.5 | 3.1 |
| OBR 1209 | 54 | 61 | 65 | 100 | 96.8 | 3.9 | −18.5 | 31 | 10.9 | 1.7 |
| OBR 1212 | 47 | 55 | 60 | 107 | 99.2 | 4.4 | −5 | 38 | 42.2 | 1.7 |
| OBR 1225 | 42.3 | 51.5 | 57.5 | 122 | 97.7 | 7.05 | −59.5 | 22.8 | 43.6 | 1.3 |
| OBR 1236 | 41 | 49 | 57 | 125 | 97.3 | 6.6 | −63 | 20 | 45 | 2.1 |
| OBR 1283 | 39 | 48 | 53 | 135 | 99.4 | 8.8 | −65 | 9.4 | 37.6 | 2.5 |
| OBR 1320 D | 38 | 49 | 56 | 133 | 99.2 | 7.6 | −65.5 | 11.4 | 44.3 | 3.6 |
| RFL 403 | 41 | 54 | 64 | 112 | 87.4 | 8.1 | −15 | 19.8 | 25.2 | 7.9 |

In the table:

O_{spez}=specific surface area in m²/g

d₅₀ (d_{z}): The diameter d̅_{z} is defined to DIN 53 206 as the median or central value of the mass distribution, above and below which half of all of the particle sizes are respectively located. The particle diameter of the latex particles is determined by ultracentrifugation (W. Scholtan, H. Lange, “Bestimmung der Teilchengröβenverteilung von Latices mit der Ultrazentrifuge”, Kolloid-Zeitschrift und Zeitschrift für Polymere 250 (1972) 782; H. G. Müller, “Automated determination of particle-size distributions of dispersions by analytical ultracentrifugation”, Colloid Polym. Sol. 267 (1989) 1113; H. G. Müller, “Determination of very broad particle size distributions via interference optics in the analytical ultracentrifuge”, Progr. Colloid Polym. Sci. 127 (2004) 9).

The diameters d₅₀ given for the latex and for the primary particles in the compositions according to the invention are practically identical, as shown in Example 1, as the size of the microgel particles remains practically unaltered during production of the composition according to the invention. This also means that the microgels in the surrounding medium are not swollen.

Glass Transition Temperature

The Perkin-Elmer DSC-2 device was used for determining Tg and the glass transition temperature range.

Swelling Index

The swelling index was determined as follows:

The swelling index was calculated from the weight of the solvent-containing microgel steeped in toluene for 24 hours at 23° C. and the weight of the dry microgel:
Swelling index=wet weight of the microgel/dry weight of the microgel.

In order to determine the swelling index, 250 mg of the microgel is steeped in 25 ml toluene for 24 hours while shaking. After centrifugation at 20,000 rpm, the (wet) gel steeped in toluene is weighed when moist and subsequently dried at 70° C. until a constant weight is reached and weighed again.

OH Number (Hydroxyl Number)

The OH number (hydroxyl number) is determined to DIN 53240 and corresponds to the amount of KOH in mg that is equivalent to the amount of acetic acid released during acetylation with acetic acid anhydride of 1 g of the substance.

Acid Number

The acid number is determined to DIN 53402 and corresponds to the amount of KOH required to neutralise 1 g of the substance.

Gel Content

The gel content corresponds to the fraction which is insoluble in toluene at 23° C. It is determined as described above.

The gel content is determined from the quotient of the dried residue and the weighed portion and is given as a percentage by weight.

Glass Transition Temperature

The glass transition temperatures were determined as stated above.

Glass Transition Temperature Range:

The glass transition temperature range was determined as described above.

Example of Microgel Paste Production in Precursors to Thermoset Production:

Production of a Microgel Paste Based on OBR 1236 and Bayflex TP PU 33IF20

Hydroxyl group-modified SBR gel (OBR 1236) in Bayflex TP PU 33IF20

The example described below demonstrates that compositions which contain mainly primary particles having an average particle diameter of approximately 40 nm may be produced using hydroxyl group-modified microgels based on SBR in a homogeniser by the application of 900 to 1,000 bar.

The following table gives the composition of the microgel paste:

| | | |
|---|---|---|
| 1. | Bayflex TP PU 33IF20 | 85,000 |
| 2. | OBR 1236 | 15,000 |
| | Total | 100,000 |

Bayflex TP PU 331E20 is a (polyether-based) product/polyol from Bayer AG that contains diethyl methyl benzene diamine, polyoxypropylene diamine and alkyl amino poly(oxyalkylen)ol. HST9317 and HST9354 differ in terms of the type of polyether used.

OBR 1236 is a crosslinked, surface-modified, SBR-based rubber gel from RheinChemie Rheinau GmbH.

For production of the composition according to the invention, Bayflex TP PU 33IF20 was provided and OBR 1236 added while stirring using a high-speed stirrer. The mixture was left for at least one day and then further processed with the homogeniser.

The composition was introduced into the homogeniser at ambient temperature and passed though the homogeniser four times at 900 to 1,000 bar batchwise. During the first cycle the microgel paste is heated to approximately 40° C., during the second cycle to approximately 70° C. The microgel paste was then cooled to ambient temperature and dispersed a third and a fourth time.

The compositions described in the following examples were produced in a similar manner, differences in the number of cycles or the homogenising pressure being given in the respective examples.

### Example 1

Characterisation of a Bayflex TP PU 33IF20 and OBR 1236-Based Microgel Paste by Ultracentrifuge and Light Scattering

1. Determining the Differential and Integral Mass Distribution by Ultracentrifuge Methods

The composition obtained above was characterised by various methods. The potential of the process is thus demonstrated by way of example.

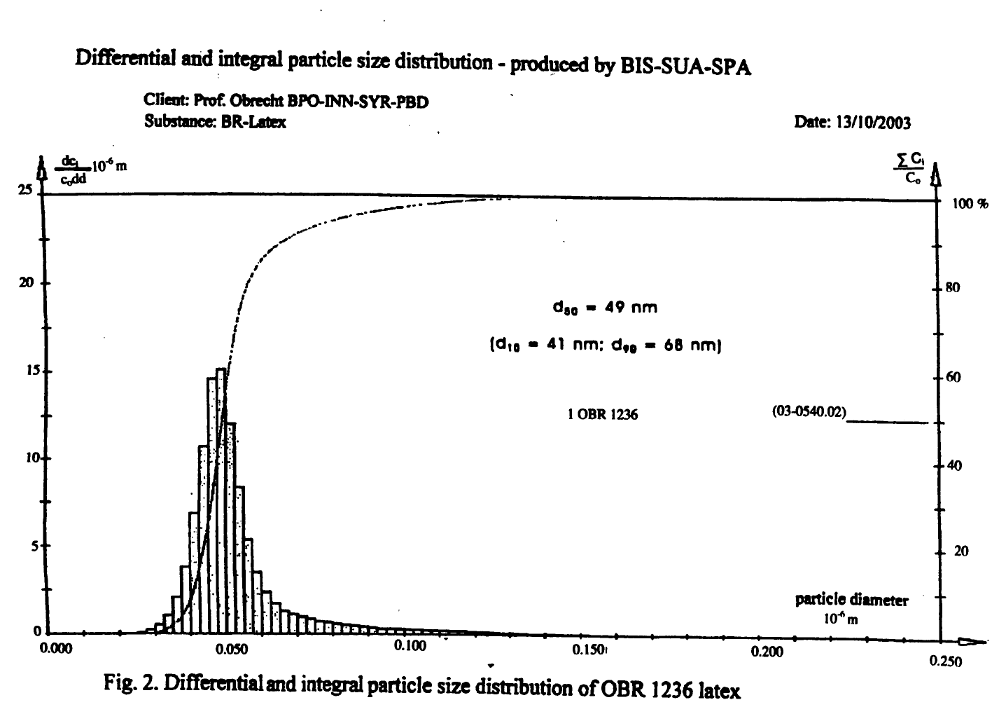

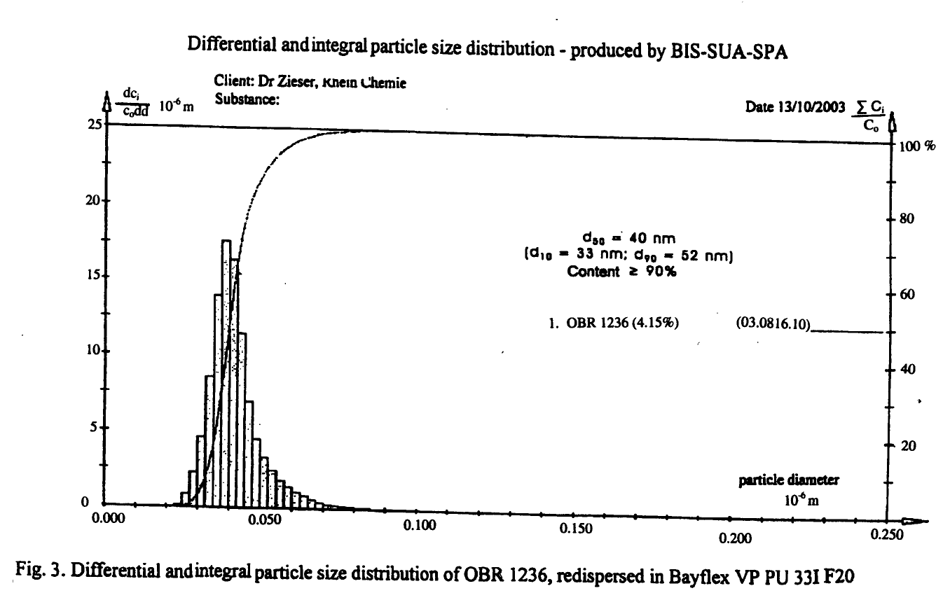

FIG. 2 shows the particle size distribution of the OBR 1236 latices; FIG. 3 shows the particle size distribution of OBR 1236 redispersed in Bayflex TP PU 33IF20.

FIGS. 2 and 3 clearly indicate that it has been possible to redisperse solid OBR 1236 in Bayflex TP PU 33IF20. The average particle diameter of the OBR latex and of the redispersed OBR 1236 differ only slightly; the usually smaller diameter of OBR 1236 in Bayflex TP PU 33IF20 is due to the compressibility of Bayflex TP PU 33IF20, which is higher than that of water (FIG. 3). Both materials contain mainly primary particles.

2. Determining the Average Hydrodynamic Diameter by Light Scattering

The average hydrodynamic diameter was measured on this sample by light scattering by an ALV correlator.

| Sample designation | Diameter |
|---|---|
| OBR 1236 (4:15%)¹⁾ | 89.0 nm |
| OBR 1236 (4:15%)²⁾ | 85.7 nm |

¹⁾Diluted sample without pre-filtration
²⁾Diluted sample pre-filtered with a 1.0 μm injection front-face filter

The differences from ultracentrifuge measurement result from the fact that large particles are over-proportional in dynamic light scattering.

Moreover, the ultracentrifuge method provides a very exact distribution and the dynamic light scattering does not provide a distribution, but rather the average hydrodynamic diameter.

### Example 2

Rheology of the Microgel-Containing Bayflex TP PU 33IF20 Pastes

The formulations in Table 2 correspond to the formulation mentioned in the production example. Differing amounts of microgel have been noted.

Baydur TP PU 1498 mod-HST9516, a polyether-based polyol, is a product from Bayer AG that contains alkylamino poly(oxyalkylen)ol, diethyl methyl benzene diamine and alkylamino carboxylic acid amide; at 20° C., the viscosity to DIN 53019 is approximately 2,000 Pas (Safety information sheet (093398/05)).

Desmophen TP PU 3218, a polyether polyol, is a product from Bayer AG. At 25° C., the viscosity to DIN 53019 of Desmophen TP PU 3218 is approximately 2,000 Pas (Safety information sheet (048252/09).

At 20° C., the viscosity to DIN 53019 of Bayflex TP PU 33IF20 is approximately 2,000 Pas (Safety information sheet (0922459/09).

TABLE 2
Viscosities η at various shear rates ν of pastes composed of Bayflex
TP PU 33IF20 and various amounts of OBR 1236; 20° C..

| | | | | | | quotient |
|---|---|---|---|---|---|---|
| | | | η at ν | η at ν = | η at ν | η(0.1 |
| | | η at ν = | = 100 | 1000 | = 0.1 | sec⁻¹) / |
| Test | | 5 sec⁻¹ | sec⁻¹ | sec⁻¹ | sec⁻¹ | η(1000 |
| designation | Characteristics | [Pas] | [Pas] | [Pas] | [Pas] | sec⁻¹) [−1] |
| PU33IF20 2 | PU33IF20-1236 | 205 | 41 | 16.7 | 5,300 | 317 |
| | 25%/1 × 500/2 × 950 | | | | | |
| | bar | | | | | |
| PU33IF20 4 | PU33IF20-1236 | 179 | 32.8 | 3.57 | 1480 | 415 |
| | 25%/1 × 500/4 × 950 | | | | | |
| | bar | | | | | |
| PU33IF20 8 | PU33IF20 | 47.2 | 13.5 | 7.82 | 1,370 | 175 |
| | OBR1236 (15%) | | | | | |
| | 4 × 950 bar | | | | | |

Table 2 shows that OBR 1236 has a marked thickening effect on Bayflex TP PU 33IF20; OBR 1236 makes TP PU 33IF20 thixotropic.

As the dispersion quality increases, the viscosities decrease.

The mixtures in Table 3 consist of Bayflex TP PU 33IF20 and OBR 1320D. The respective amounts of microgel and dispersion conditions have been noted.

TABLE 3
Viscosities at various shear rates of pastes composed of Bayflex TP PU
33IF20 or Baydur PU1498/mod - HST9516 and various
amounts of OBR 1320D; 60° C..

| | | | | Viscosity at |
|---|---|---|---|---|
| | | | Viscosity | shear rate 5 s⁻¹/ |
| | | Viscosity | at shear rate | Viscosity at |
| | | at shear rate 5 s⁻¹ | 1000 s⁻¹ | shear rate 1000 s⁻¹ |
| Test designation | Characteristics | [Pa * s] | [Pa * s] | [ ] |
| PU33IF20- | 15% OBR | 5.79 | 0.68 | 9 |
| HST9317 | 1320D; | | | |
| | 4 × 950 bar | | | |
| PU33IF20 | 15% OBR | 33.20 | 0.88 | 38 |
| HST9354 | 1320D; | | | |
| | 4 × 950 bar | | | |
| PU1498/mod - | 25% OBR | 17.00 | 1.02 | 17 |
| HST9516 | 1320D; | | | |
| | 4 × 950 bar | | | |

OBR 1320D has a higher viscosity in Bayflex TP PU 33IF20, HST9354 than in Bayflex TP PU 33IF20, HST9317. The marked thickening effect of the microgel in various liquid matrices is apparent even at 60° C.

The mixtures in Table 4 consist of Desmophen TP PU 3218 and OBR 1236. The respective amounts of microgel and dispersion conditions have been noted. It will be demonstrated below that microgel pastes, at a suitable microgel concentration, may also be produced using the triple roller.

TABLE 4
Viscosities at various shear rates of pastes composed of Desmophen
TP PU 3218 and various amounts of OBR 1236; 20° C..

| | | | | | | Quotient |
|---|---|---|---|---|---|---|
| | | | | | | η (0.1 |
| | | ηat ν | ηat ν | ηat ν | ηat ν | sec⁻¹)/ |
| | | = 5 | = 100 | = 1,000 | = 0.1 | η (1,000 |
| Test | | sec⁻¹ | sec⁻¹ | sec⁻¹ | sec⁻¹ | sec⁻¹) |
| designation | Characteristics | [Pas] | [Pas] | [Pas] | [Pas] | [ ] |
| D32186 | D3218 OBR | 216 | 32.8 | 5.24 | 2,030 | 387 |
| | (30%) | | | | | |
| | 1 × 30; | | | | | |
| | 3 × 40¹⁾ | | | | | |
| D32188 | D3218 OBR | 723 | 71.5 | 3.71 | 2,390 | 644 |
| | (40%) | | | | | |
| | 1 × 30; | | | | | |
| | 1 × 40¹⁾ | | | | | |

¹⁾Produced using the triple roller at 30 or 40 bar roll pressure

OBR 1236 also has a marked thickening effect on Desmophen TP PU 3218; OBR 1236 makes Desmophen TP PU 3218 highly thixotropic. The indicated, surprisingly marked thickening by microgels of a suitable composition demonstrates the potential of said microgels as rheological additives.

### Example 3

Production of Microgel-Containing Thermosetting Plastics Compositions with RC-PUR KE 9686 and RC-DUR 302 Systems

This example discloses which rheological properties the illustrated pastes have, how microgel-containing pastes are mechanically reacted with the curing agent component to form a thermoset material, and which mechanical characteristics are measured on the resulting thermoset materials.

RC-PUR KE 9686 is a product (A component) that is commercially available from Rheinchemie Rheinau GmbH for the production of polyurethanes, und RC-DUR 302 the associated B component, an aliphatic isocyanate, which is also a product that is commercially available from Rheinchemie Rheinau GmbH. At 20° C., the viscosity of RC-PUR KE 9686 is 2,600 Pas (technical information sheet RC-PUR KE 9686: version 1/2000).

a) Rheology of the Microgel-Containing RC-PUR KE 9686 Pastes

Table 5 shows the viscosities of the microgel-containing pastes (OBR 1209, OBR 1212, OBR 1225) at various shear rates and a temperature of 20° C.

TABLE 5
RC-PUR KE 9686-X: Viscosities of the microgel-containing pastes at various shear rates; 20° C..

| | | | Viscosity | Viscosity | Viscosity | Viscosity | |
|---|---|---|---|---|---|---|---|
| | Concentration | | at shear | at shear | at shear | at shear | Quotient |
| | of the | | rate | rate | rate | rate | η (0.1 sec⁻¹)/ |
| | microgel | | γ = 5 s⁻¹ | γ = 100 s⁻¹ | γ = 1,000 s⁻¹ | γ = 0.1 s⁻¹ | η (1,000 sec⁻¹) |
| Microgel | [%] | Dispersion | [mPas] | [mPas] | [mPas] | [mPas] | [—] |
| OBR1209 | 2.5 | 4 × 950 | 3.4 | 3.0 | 2.6 | 2.8 | 1.1 |
| OBR1209 | 14 | 4 × 950 | 8.8 | 6.4 | 5.0 | 7.9 | 1.6 |
| OBR1212 | 2.5 | 4 × 950 | 3.7 | 3.1 | 2.6 | 2.8 | 1.1 |
| OBR1225 | 2.5 | 4 × 950 | 3.7 | 3.2 | 2.7 | 4.2 | 1.6 |
| OBR1225 | 13 | 4 × 950 | 16.8 | 8.7 | 5.8 | 24 | 4.1 |

It is apparent from the values in Table 5 that the microgels OBR 1209, OBR 1212 and, in particular, OBR 1225 increase the viscosity as the microgel concentration rises at various shear rates.

The increase in viscosity caused by these microgels is smaller than in the case of the above-described microgels, so they are particularly beneficial for applications in which high microgel concentrations are desirable, in order, for example, markedly to influence the mechanical characteristics, while processability is also good.

b) Mixing of the Microgel-Containing Thermoset Material Precursor Pastes with RC-DUR 302

RC-DUR 302 (isocyanate (iso)) was added to the microgel-containing polyol pastes using a 2-K low-pressure machine, the mixture was blended and poured into moulds.

T paste is a product from UOP that is used to reduce the water content.

TABLE 6
RC-PUR KE 9686-X: Pouring conditions in machine processing

| | | | | | | | | Material | |
|---|---|---|---|---|---|---|---|---|---|
| | | | | | | | Mould | temperature | |
| | | Degassing | Gears | | Mixing ratio | | temperature | (° C.) | |
| Sample name | Composition | period | Polyol | Iso | Real | Ideal | (° C.) | Polyol | Iso |

| | | | | | | | |
|---|---|---|---|---|---|---|---|
| RC-PUR KE | 0% | 2 h 30 min | 22:26 | 100:173 | 100:173 | 75 | 60/60 |
| 9686 | | at 60° C. | | | | | |
| RC-PUR KE | 14% OBR 1212 | 2 h at 60° C. | 20:28 | 100:153 | 100:149 | 70/90 | 60/60 |
| 9686-2 | | | | | | | |
| RC-PUR KE | 14% OBR 1225 | 2 h at 60° C. | 20:28 | 100:153 | 100:150 | 70 | 60/50 |
| 9686-6 | | | | | | | |
| RC-PUR KE | 14% OBR 1135 + | Overnight | 20:28 | 100:154 | 100:149 | 70 | 60/60 |
| 9686-11 | 6% T paste | at 60° C. | | | | | |
| RC-PUR KE | 14% OBR 1209 | 2 h at 60° C. | 20:28 | 100:154 | 100:149 | 70 | 60/60 |
| 9686- 16 | | | | | | | |

c) Production of the Specimens

The specimens for the tensile test are punched and the specimens for the Shore hardness measurements cut from the forms cast as under b). The specimens have to have smooth edges and be free of notches and air pockets.

d) Shore D Hardness

Table 7 shows the results of the Shore D hardness measurements.

TABLE 7
RC-PUR KE 9686-X: Shore D hardness of the polyurethane, produced
from microgel-containing RC-PUR KE 9686 and RC-DUR 302.

| Sample name | Composition | Shore D |
|---|---|---|
| RC-PUR KE 9686 | 0% | 82 |
| RC-PUR KE 9686-2 | 14% OBR 1212 | 81 |
| RC-PUR KE 9686-6 | 14% OBR 1225 | 80 |
| RC-PUR KE 9686-11 | 14% OBR 1135 | 83 |
| RC-PUR KE 9686-16 | 14% OBR 1209 | 80 |

It may be seen that the addition of up to 14% by weight of microgel to RC-PUR KE 9686 does not have any significant influence on the Shore hardness of the resulting PU.

All of the measured values lie in the same range (80 to 83 Shore D), i.e. although the elongation at break is markedly increased by the addition of microgels, as will be shown below, it is possible to maintain the high Shore hardness (Table 8).

e) Tensile Test on the RC-PUR KE 9686 and RC-DUR 302 Systems

Table 8 shows the results of the tensile tests, which were measured on the specimens; these specimens were produced in the manner described in sections b) and c).

TABLE 8
RC-PUR KE 9686-X: tensile test (testing speed 12.5 mm/min, 23° C.)

| | | εbreak |
|---|---|---|
| Sample name | Composition | [%] |
| RC-PUR KE 9686 | 0% | 10.7 |
| RC-PUR KE 9686-2 | 14% OBR 1212 | 18.1 |
| RC-PUR KE 9686-6 | 14% OBR 1225 | 16.4 |
| RC-PUR KE 9686-11 | 14% OBR 1135 | 31.6 |
| RC-PUR KE 9686-16 | 14% OBR 1209 | 18.1 |

It is apparent from Table 8 that, compared to the microgel-free RC-PUR KE 9686, the elongation at break ε_{break} increases as a result of the addition of microgel.

f) Charpy Impact Strength of the Microgel-Containing RC-PUR KE 9686 and RC-DUR 302 Systems

Test pieces to DIN 53453 were used as the specimens.

TABLE 9
RC-PUR KE 9686-X: Charpy impact strength to
DIN EN ISO 179 at 23° C.

| | | Standard | | MG | |
|---|---|---|---|---|---|
| | Impact strength | deviation | Variance | content | |
| Material | [kJ/m²] | [kJ/m²] | [%] | [%] | Microgel |
| 9686-0 | 51 | 21 | 42 | 0 | — |
| 9686-2 | 93 | 19 | 20 | 14 | OBR |
| | | | | | 1212 |
| 9686-6 | 38 | 12 | 33 | 14 | OBR |
| | | | | | 1225 |
| 9686-16 | 73 | 9 | 12 | 14 | OBR |
| | | | | | 1209 |

It is clear from Table 9 that the addition of only 5% by weight of microgel (OBR 1209, OBR 1212) (based on PU) allows the impact strength to be significantly increased; this was not possible with OBR 1225.

### Example 4

Production of Thermosetting Plastics Compositions Comprising the Microgel-Containing Epilox Diluent P13-26 and Epilox Curing Agent IPD

This example describes how a microgel-free and a microgel-containing epoxide resin paste were reacted with the curing agent component to form thermoset materials, and which mechanical characteristics were measured on the resulting thermoset materials.

Epilox diluent P13-26, a cyclohexane dimethanol-based diglycidyl ether, is a product for the production of epoxide resins (EP) that is commercially available from Leuna-Harze GmbH, and Epilox curing agent IPD is a cycloaliphatic polyamine that is also commercially available from Leuna-Harze GmbH.

Disperbyk 2070, a dispersant, and Byk A 530, a deaerator, are commercially available from Byk-Chemie GmbH.

OBR 980 is a laboratory product from Rheinchemie Rheinau GmbH/Lanxess; it is described in the production examples.

The microgel-free and the microgel-containing epoxide resin pastes were reacted in an equimolar mixture with the curing agent component, Epilox curing agent IPD, to form thermoset materials. Pouring off was performed manually.

The Shore D hardness of the microgel-free and the 20% OBR 980-containing EP mixture is given in Table 10 (below).

TABLE 10
Shore D hardness of the microgel-free and the microgel-containing
epoxide resin based on Epilox diluent P13-26 and Epilox IPD.

| | Microgel content | |
|---|---|---|
| Designation | [%] | Shore hardness D |
| Epilox P13-26-III | 0 | 82 |
| Epilox P13-26-IV¹⁾ | 19.7 (OBR 980) | 72 |

¹⁾comprising 3% Disperbyk 2070 and 0.2% Byk A 530 (based on the total formulation)

The material comprising 20% by weight OBR 980 has a lower hardness than the material without microgel, and this, like the tensile test, suggests a microgel network in the EP material (Table 11).

TABLE 11
Tensile test on the reaction products consisting of Epilox diluent P 13-26
without or with OBR 980 and Epilox curing agent IPD; 23° C..

| | Microgel content | Elongation at break □B |
|---|---|---|
| Designation | [%] | [%] |
| Epilox P13-26-III | 0 | 7.6 |
| Epilox P13-26-IV1) | 19.7 (OBR 980) | 40 |

1)comprising 3% Disperbyk 2070 and 0.2% Byk A 530 (based on the total formulation)

A marked increase in the elongation at break is observed for 20% by weight OBR 980. The elongation at break increased by more than 500% compared to the microgel-free EP.

### Example 5

Characterisation of Various Polyol-, Polyisocyanate- or Epoxy Resin-Based Microgel Pastes with Respect to their Rheological Properties

Table 12 shows the viscosities the microgel-containing pastes (OBR 1009, OBR 1155, RFL 403A) at various shear rates and a temperature of 20° C.

Desmodur PA09, a diphenylmethane diisocyanate (MDI)-based preparation, is commercially available from Bayer MaterialScience; at 25° C., the viscosity to DIN 53019 is approximately 500 mPas (Safety information sheet 045598/14). Epilox T19-36/1000, a reactively diluted epoxide resin, is commercially available from Leuna-Harze GmbH; at 25° C., the viscosity to DIN 53015 is 1150 mPas (information sheet T19-36, December 00). Epilox P 13-20, a hexanediol diglycidyl ether, is commercially available from Leuna-Harze GmbH; at 25° C., the viscosity to DIN 53015 is 20 mPas (Information sheet P13-20, March 01).

The microgel-containing precursors were dispersed in the homogeniser at the specified pressures.

TABLE 12
Viscosities of the microgel-containing pastes containing Desmodur PA09, Epilox T19-36/1000
and Epilox P 13-20 at various shear rates; 20° C..

| | | Viscosity η | Viscosity | Viscosity | Viscosity | Quotient |
|---|---|---|---|---|---|---|
| | | at ν = 5 sec⁻¹ | ην = 100 sec⁻¹ | ην = 1,000 sec⁻¹ | ην = 0.1 sec⁻¹ | η (0.1 sec⁻¹)/ |
| | | (20° C.) | (20° C.) | (20° C.) | (20° C.) | η (1000 sec⁻¹) |
| Designation | Characteristics | [mPas] | [mPas] | [mPas] | [mPas] | □ |
| Desmodur PA09 | 10% OBR 1155 | 16,500 | 11,500 | 9,640 | 17,000 | 1.8 |
| -OBR 1155 | 4 × 970 bar | | | | | |
| T19-36 2 | T19-36 (0%) | 2,800 | 2,790 | 2,730 | 1,780 | 0.7 |
| | 2 × 960 bar | | | | | |
| T19-36 8 | T19-36 | 78,200 | 20,400 | 10,300 | 581,000 | 56 |
| | OBR 1009 | | | | | |
| | (10.7%) | | | | | |
| | 2 × 910 bar | | | | | |
| Epilox-P13-20 | 60% RFL 403A | 297,000 | 28,200 | 4,200 | 857,000 | 204 |
| | 2 × 900 bar | | | | | |

It is apparent from the values in Table 12 that the rheology is influenced much more markedly by the addition of microgels than would be expected from Einstein's viscosity equation (M. Mooney, The viscosity of a concentrated suspension of spherical particles, J. Colloid. Sci. 6 (1951) 162).

It can be shown that microgels also have a marked thickening effect in polyisocyanates and in epoxide resins; they are suitable as rheological additives.

Surprisingly, it was possible to incorporate even 60% by weight RFL 403A into Epilox P 13-20; at a high shear, this solid paste, which at a shear rate ν of 5 s⁻¹ has a viscosity of 297,000 mPas, exhibits a viscosity of just 4,200 mPas (ν=1000 s⁻¹).

1. Thermosetting plastics composition, containing at least one thermosetting plastics material (A) and at least one crosslinked microgel (B), of which the average primary particle diameter is from 5 to 500 nm.

2. Thermosetting plastics composition, containing at least one thermosetting plastics material (A) and at least one homopolymer- or random copolymer-based microgel (B) that is not crosslinked by high-energy radiation.

3. Thermosetting plastics composition according to either claim 1 or claim 2, characterised in that the primary particles of the microgel (B) have approximately spherical geometry.

4. Thermosetting plastics composition according to any one of claims 1 to 3, characterised in that the deviation in the diameter of an individual primary particle of the microgel (B), defined as
[(d1−d2)/d2]×100,
wherein d1 and d2 are two arbitrary diameters of an arbitrary section of the primary particle and d1 is >d2, is less than 250%.

5. Thermosetting plastics composition according to any one of claims 1 to 4, characterised in that the microgels (B) comprise contents, which are insoluble in toluene at 23° C., of at least approximately 70% by weight.

6. Thermosetting plastics composition according to any one of claims 1 to 5, characterised in that the microgels (B) have a swelling index of less than 80 in toluene at 23° C.

7. Thermosetting plastics composition according to any one of claims 1 to 6, characterised in that the microgels (B) exhibit glass transition temperatures from −100° C. to +120° C.

8. Thermosetting plastics composition according to any one of claims 1 to 7, characterised in that the microgels (B) have a glass transition range greater than approximately 5° C.

9. Thermosetting plastics composition according to any one of claims 1 to 8, characterised in that the microgels (B) may be obtained by emulsion polymerisation.

10. Thermosetting plastics composition according to any one of claims 1 to 9, characterised in that it exhibits a shear modulus greater than 10 MPa in a temperature range from −150 to +200° C.

11. Thermosetting plastics composition according to any one of claims 1 to 10, characterised in that the ratio by weight of thermosetting plastics material (A) to microgel (B) is from 0.5:99.5 to 99.5:0.5.

12. Thermosetting plastics composition according to any one of claims 1 to 11, characterised in that the ratio by weight of thermosetting plastics material (A) to microgel (B) is from 10:90 to 90:10, particularly preferably 20:80 to 80:20.

13. Thermosetting plastics composition according to any one of claims 1 to 13, characterised in that the microgel (B) comprises functional groups.

14. Thermosetting plastics composition according to claim 13, characterised in that the functional group is a hydroxyl, epoxy, amine, acid anhydride, isocyanate or unsaturated group.

15. Thermosetting plastics composition according to any one of claims 1 to 14, characterised in that the thermosetting plastics material (A) is selected from the group consisting of thermosetting condensation polymers, thermosetting addition polymers and thermosetting polymerisation resins.

16. Thermosetting plastics composition according to claim 15, characterised in that the thermosetting condensation polymers are selected from the group consisting of phenolic resins, amino resins, furan resins and polyimides, the thermosetting addition polymers are selected from the group consisting of epoxide resins and polyurethanes, and the thermosetting polymerisation resins are selected from the group consisting of allyl compounds, unsaturated polyesters, vinyl or acrylic esters.

17. Thermosetting plastics composition according to any one of claims 1 to 16, characterised in that the thermosetting plastics material (A) is selected from the group consisting of:
diallyl phthalate resins (PDAP),
epoxide resins (EP),
aminoplastics such as urea-formaldehyde resins (UF), melamine-formaldehyde resins (MF),
phenolics such as melamine-phenol-formaldehyde resins (MP), phenol-formaldehyde resins (PF), cresol-formaldehyde resins (CF), resorcinol-formaldehyde resins (RF), xylenol-formaldehyde resins (XF),
furfuryl alcohol-formaldehyde resins (FF),
unsaturated polyester resins (UP),
polyurethane resins (PU)
reaction injection-moulded polyurethane resins (RIM-PU)
furan resins
vinyl ester resins (VE, VU),
polyester melamine resins and
mixtures of diallyl phthalate (PDAP) or diallyl isophthalate (PDAIP) resins.

18. Thermosetting plastics composition according to any one of claims 1 to 17, characterised in that the thermosetting plastics material (A) is selected from the group consisting of epoxide resins, aminoplastics, phenolics, unsaturated polyester resins and reaction injection-moulded polyurethane resins.

19. Thermosetting plastics composition according to any one of claims 1 to 18, containing one or more polymer additives.

20. Thermosetting plastics composition according to claim 19, wherein the additive is selected from the group consisting of: fillers and reinforcing materials, pigments, UV absorbers, flame retardants, defoaming agents, deaerators, wetting and dispersing agents, fibres, fabrics, catalysts, thickening agents, anti-settling agents, anti-shrinking agents, thixotropic agents, release agents, flow control agents, flatting agents, corrosion inhibitors, slip additives and biocides.

21. Use of crosslinked microgels (B) having an average primary particle diameter from 5 to 500 nm for the production of thermosetting plastics compositions.

22. Process for the production of thermosetting plastics compositions according to any one of claims 1 to 20, characterised in that it comprises the following steps:
a) dispersion of the microgel (B) having an average primary particle diameter from 5 to 500 nm in one or more starting products, which are capable of forming the thermosetting plastics material (A), or a solution thereof, which optionally contain polymer additives that are advantageously added prior to dispersion,
b) optionally addition of further components and
c) curing or crosslinking of the dispersion obtained.

23. Process according to claim 22, wherein step c) takes place with simultaneous moulding.

24. Process according to either claim 22 or claim 23, wherein the starting product, which is capable of forming the thermosetting plastics material (A), is selected from monomers, oligomers (prepolymers) or curing agents or crosslinking agents therefor.

25. Process according to any one of claims 22 to 24, characterised in that the starting product, which is capable of forming the thermosetting plastics material (A), is selected from the group consisting of:
polyols and mixtures thereof,
aliphatic polyether polyols and mixtures thereof,
aliphatic polyester polyols and mixtures thereof,
aromatic polyester polyols and mixtures thereof,
polyether polyester polyols and mixtures thereof,
unsaturated polyesters and mixtures thereof,
aromatic alcohols or mixtures thereof,
styrene,
polyisocyanates,
isocyanate resins,
epoxide resins,
phenolic resins,
furan resins,
caprolactam,
dicyclopentadiene,
aliphatic polyamines,
polyamidoamines,
aromatic polyamines,
(meth)acrylates,
polyallyl compounds,
vinyl esters,
state A thermosetting condensation polymers and also
derivatives or solutions of the above-mentioned starting products.

26. Process according to any one of claims 22 to 25, wherein the microgel (B) and the starting products, which are capable of forming the thermosetting plastics material, are treated together in a homogeniser, a ball mill, a bead mill, a roll mill, a triple roller, a single- or multi-screw extruder, a kneader and/or a high-speed stirrer.

27. Process according to any one of claims 22 to 26, wherein the microgel (B) and the starting products, which are capable of forming the thermosetting plastics material, are treated together in a homogeniser.

28. Thermosetting plastics compositions obtainable by the processes according to any one of claims 22 to 27.

29. Thermosetting plastics composition obtainable by curing or crosslinking a dispersion, containing at least one starting product, which is capable of forming a thermosetting plastics material, and at least one crosslinked microgel (B), the average primary particle diameter of which is from 5 to 500 nm, wherein the average particle diameter is determined to DIN 53206 by ultracentrifugation of the dispersion.

30. Thermosetting plastics composition according to claim 29, wherein said dispersion is obtained by treating the dispersion in a homogeniser, a ball mill, a bead mill, a roll mill, a triple roller, a single or multi-screw extruder, a kneader and/or a high-speed stirrer, preferably in a homogeniser.

31. Use of the thermosetting plastics compositions according to any one of claims 1 to 20, 29 and 30 or of the thermosetting plastics compositions obtainable by the processes according to any one of claims 22 to 27 as a moulded article, a coating or a bonding material.

32. Use of the thermosetting plastics compositions according to any one of claims 1 to 20, 29 and 30 or of the thermosetting plastics compositions that may be obtained by the processes according to any one of claims 22 to 27 in electronic components or in constructional components.

33. Use of microgels, the average primary particle diameter of which is from 5 to 500 nm, as a rheological additive, in particular as a thickener and/or a thixotropic agent, in one or more starting products, which are capable of forming the thermosetting plastics material (A), or a solution thereof, that contains reactants having an average functionality per molecule typically of ≧3.

34. Compositions containing one or more crosslinked microgels (B), the average primary particle diameter of which is from 5 to 500 nm, and one or more starting products, which are capable of forming a thermosetting plastics material (A), wherein at least 20% by weight of the starting products consist of crosslinkable components having an average functionality of ≦3.
